(19) United States
(12) Patent Application Publication
(10) Pub. No.: US 2015/0162772 A1
(43) Pub. Date: Jun. 11, 2015

(54) VOLTAGE CUTOFF CIRCUIT FOR AN ELECTROCHEMICAL CELL

(71) Applicant: Electrochem Solutions, Inc., Clarence, NY (US)

(72) Inventors: Brian R. Peterson, Norton, MA (US); Eric Jankins, Raynham, MA (US); Arden P. Johnson, Arlington, MA (US); James K. Stawitzky, North Tonawanda, NY (US); Jon J. Carroll, Attleboro, MA (US); John A. Hession, Braintree, MA (US)

(73) Assignee: Electrochem Solutions, Inc., Clarence, NY (US)

(21) Appl. No.: 14/195,267

(22) Filed: Mar. 3, 2014

Related U.S. Application Data
(60) Provisional application No. 61/771,579, filed on Mar. 1, 2013.
(60) Provisional application No. 61/771,407, filed on Mar. 1, 2013.

(51) Int. Cl. H02J 7/00

(52) U.S. Cl. CPC H02J 7/0063

(57) ABSTRACT

An electrical circuit designed to dynamically connect or disconnect an electrochemical cell to or from an electrical load based on the measured value of the discharge voltage generated by the cell is discussed. When the measured discharge voltage of an electrochemical cell is less than the threshold voltage, the cell is disconnected from an electrical load and when the discharge voltage is the same as, or greater than, the threshold voltage, the electrochemical cell is connected to an electrical load. The circuit is configured so that the value of the threshold voltage increases from an initial value when the electrochemical cell is first disconnected from the electrical load.

### CROSS-REFERENCE TO RELATED APPLICATIONS

This application claims priority from U.S. Provisional Patent Application Ser. Nos. 61/771,407 and 61/771,579, both filed Mar. 1, 2013.

### FIELD OF THE INVENTION

The present invention relates to a circuit for operating a lithium oxyhalide electrochemical cell. In particular, the invention relates to a circuit for safely operating a lithium thionyl chloride electrochemical cell.

### PRIOR ART

Primary lithium oxyhalide cells are used extensively in applications requiring high gravimetric and volumetric energy density. Among the many sizes and chemistries available, cells can be developed for low rate or high rate applications and to operate from temperatures as low as −70° C. to as high as 200° C. The anode material usually consists of lithium or lithium alloyed with various elements such as aluminum, magnesium or boron. The cathode usually consists of some form of carbon which is held together using a suitable binder. The electrolyte generally consists of a solvent system of thionyl chloride, phosphoryl chloride or sulfuryl chloride. Often, additional compounds or interhalogen compounds such as sulfur dioxide, chlorine, bromine, bromine chloride and others may be dissolved therein to modify the cell for a particular purpose, such as extending the operating rate or temperature range of the cell. Electrolyte salts are also added to the solvent system to assist in ionic transfer during cell discharge. Such salts may include lithium chloride in combination with aluminum trichloride or gallium trichloride. Lithium tetrachloroaluminate salt (LAC) or lithium tetrachlorogallate salt (LGC) is then formed in-situ. Typically used catholytes include chlorinated sulfuryl chloride (CSC) having either LAC or LGC dissolved therein. These systems are commonly referred to as LAC/CSC and LGC/CSC.

Safety problems may result due to external electrical or mechanical abuse or internal failures of lithium batteries. An internal or external short circuit causes the cell temperature to rise. If the internal cell temperature of a lithium battery reaches the lithium melting point of about 180° C., melting of the lithium can result in rapid exothermic reactions that may cause catastrophic rupture of the cell.

The potential that a primary lithium cell may become unstable or rupture as a result of a short circuit is of particular concern for those utilizing lithium primary cells in hazardous environments, such as those environments comprising a flammable gas. Examples of these environments include oil and gas wells as well as some industrial settings. The electrical performance and wide temperature range of these primary lithium electrochemical cells make them ideal for powering a wide range of electrical devices in harsh environments. However, special precautions should be used when operating primary lithium oxyhalide cells, especially in hazardous environments.

An electrochemical cell that operates an electrical device in an explosive environment must comply with specific safety requirements that are defined in International Electrotechnical Commission (IEC) Standard 60079-11 “Electrical Apparatus for Explosive Gas Atmospheres: Intrinsic Safety”. The standard defines various test parameters that must be passed by an electrical device and the electrochemical cell that powers the device before the device and cell can be certified to operate in an explosive gas atmosphere. According to the standard, a battery that is to be used in an explosive gas environment must not vent or rupture under a short circuit condition. Secondly, the cell is not to cause ignition of a defined flammable gas when a short circuit is applied to the cell.

In addition to the concern about the possibility of a cell rupture due to a short circuit, a primary lithium oxyhalide cell may become unstable when the cell is discharged beyond its useful life. In the case of a primary lithium thionyl chloride cell, SO₂ gas evolves within the cell's casing as a function of depth of discharge. As the SO₂ gas evolves within the cell during use, atmospheric pressure increases within the cell's casing. If swelling of the cell occurs, the electrolyte may leak from the casing. The leak can be slow, rapid or anywhere in-between. Whatever the leak rate, electrolyte leaks are undesirable and can damage that which is being powered by the cell.

Furthermore, as the primary cell reaches full depth of discharge, small amounts of the lithium anode may migrate throughout the cell, thereby possibly contributing to the electrical instability of the cell. Thus, as a precautionary safety measure, the energy capacity of a primary lithium chloride cell is usually not fully discharged. To minimize electrical instability and thus, reduce the possibility of cell rupture, the cell is usually disconnected from the electrical load before full cell discharge is achieved. Electrical circuits have been developed that disconnect a primary lithium electrochemical cell from the load when the cell's discharge voltage reaches a predetermined threshold or cutoff voltage. It is generally understood to those of ordinary skill in the art that the useful life of a primary lithium cell, for example of a moderate rate size D cell, is completed when it is depleted to about 1.5 volts as measured over an open circuit.

One such electrical cutoff circuit is disclosed in U.S. Pat. No. 7,586,292 to Wakefield et al., which is assigned to the assignee of the present invention and incorporated herein by reference. Wakefield discloses an electrical circuit that utilizes a sensing circuit and an electrical switch to disconnect the cell from an electrical load when a predetermined discharge voltage is reached. However, after the circuit has been activated, and the cell has been disconnected from the load, the circuit must be manually reset for it to be activated again. This manual reset switch feature of the Wakefield circuit is not particularly desirable in situations where a cell may have been inadvertently disconnected from the load being powered prior to the end of the useful life of the cell.

For example, lithium oxyhalide cells, particularly lithium thionyl chloride electrochemical cells, are prone to exhibit voltage delay under some use conditions. In the lithium oxyhalide chemistry, the voltage delay phenomenon is primarily attributed to a passivation layer which forms on the lithium anode when in contact with the catholyte.

Specifically, the voltage delay phenomenon generally manifests itself as a rapid decrease in discharge voltage when an external load is placed upon the cell or battery, such as during the application of a short duration pulse or during a pulse train. Voltage delay can take one or both of two forms. One form is that the leading edge potential of the first pulse is lower than the end edge potential of the first pulse. In other words, the voltage of the cell at the instant a load is applied is lower than the voltage of the cell immediately before the load is removed. The second form of voltage delay is that the minimum potential of a first load is lower than the minimum potential of the last load when a series of loads have been applied. In either case, such a sharp decrease in discharge voltage, particularly when an electrical load is initially connected to the cell, may inadvertently cause these prior art voltage cutoff protection circuits, such as the one disclosed by Wakefield, to disconnect the cell from the load prior to depletion of the cell's useful life. Thus, in the case of the Wakefield circuit, the circuit would be required to be manually reset.

Accordingly, the present invention is directed to providing a voltage cutoff circuit that is capable of dynamically connecting and disconnecting an electrochemical cell to a load without the need for a reset switch. In addition, the voltage cutoff protection circuit of the present invention is designed to minimize inadvertent disconnections of the load due to the voltage delay phenomenon typically of primary lithium oxyhalide cells. Furthermore, other features are provided that enhance the operating safety of primary lithium oxyhalide cells when powering devices in hazardous environments, particularly explosive gas atmospheres.

### SUMMARY OF THE INVENTION

The object of the present invention is, therefore, to provide an electrical circuit that is capable of dynamically connecting and disconnecting an electrochemical cell from an electrical load based on measurement of the cell's discharge voltage without the need for a reset switch. Specifically, the voltage cutoff circuit of the present invention comprises a voltage comparator that works in conjunction with a series of resistors and field effect transistors to create a voltage hysteresis, whereby the value of the measured discharge voltage required to reconnect a cell to the an electrochemical load is greater than the value of the cutoff discharge voltage. Thus, when the threshold cutoff voltage is reached, and the cell is disconnected from the electrical load, the circuit requires that the cell achieve a recovery voltage, i.e., a discharge voltage that is greater than the cutoff threshold voltage, before the cell is reconnected to the load. Therefore, if a dramatic drop in a cell's discharge voltage where to happen, due, for example, to the voltage delay effect, the circuit would reconnect the cell to the load when a specified recovery discharge cell voltage is achieved.

In addition, a fuse is incorporated within the electrical circuit to minimize the possibility of cell venting resulting from a short circuit. Furthermore, the present invention provides various features that improve the operational safety of an electrochemical cell, particularly that of a primary lithium oxyhalide cell.

These and other objects of the present invention will become increasingly more apparent to those skilled in the art by reference to the following description and to the appended drawings.

### BRIEF DESCRIPTION OF THE DRAWINGS

FIG. 1 is an electrical schematic diagram of an embodiment of the electrical circuit of the present invention.

FIG. 2 is a graph illustrating the discharge voltage as a function of cell capacity for a typical primary lithium oxyhalide electrochemical cell.

FIG. 3 is a graph illustrating an embodiment of the oscillating effect of the discharge voltage that occurs when a cell is connected to an electrical circuit that does not comprise a voltage hysteresis control feature of the present invention.

FIG. 4 illustrates a graph showing an embodiment of the preferred discharge voltage hysteresis effect that occurs when an electrochemical cell is connected to an electrical circuit of the present invention.

FIG. 5 is an electrical schematic diagram of a preferred embodiment of the electrical circuit of the present invention.

FIG. 5A is an electrical schematic diagram of an alternative embodiment of a voltage comparator that could be utilized with the electrical circuit of the present invention.

FIG. 6 illustrates a cross-sectional view of an electrochemical cell comprising an external layer of an encapsulate material.

### DETAILED DESCRIPTION OF THE PREFERRED EMBODIMENTS

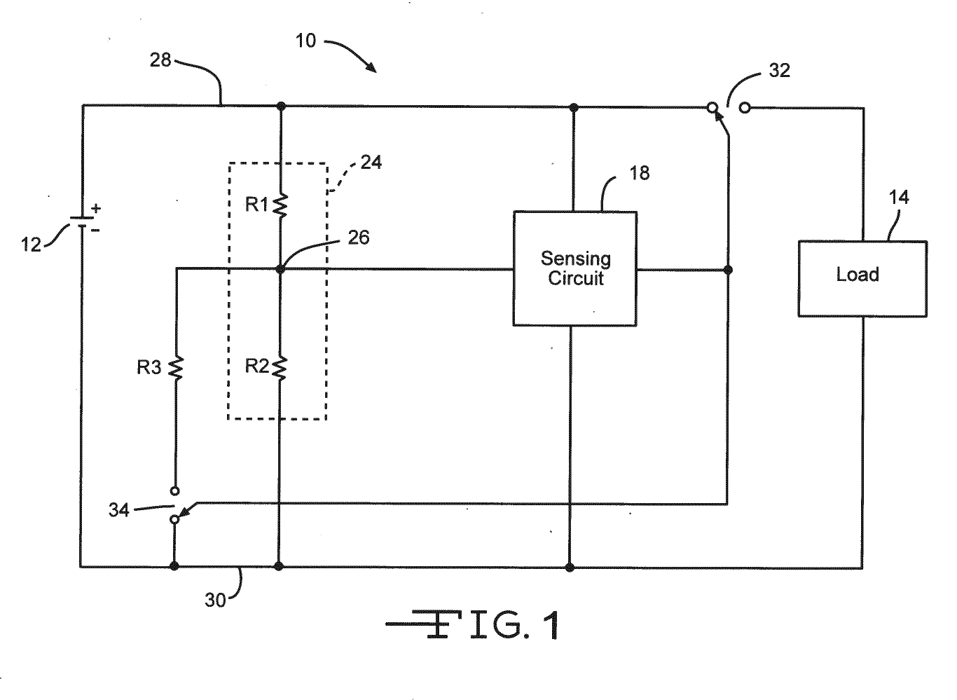

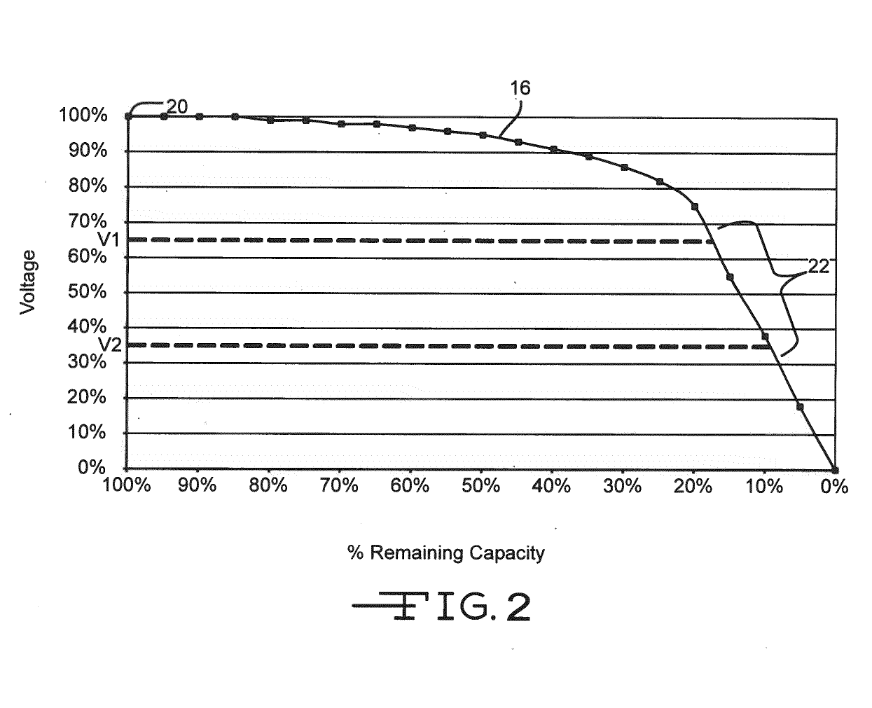

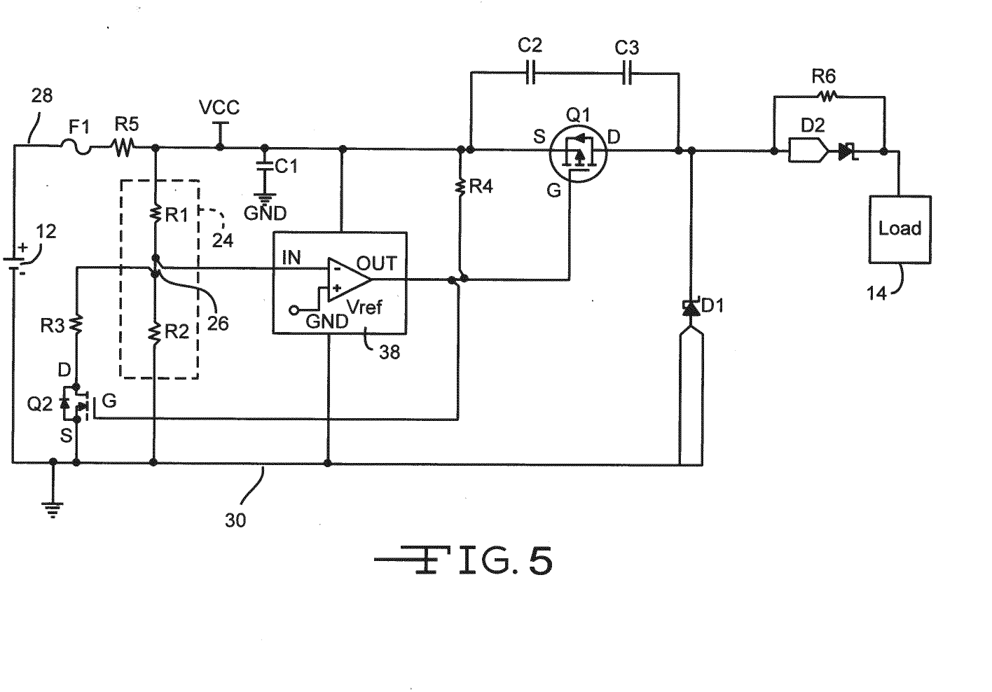

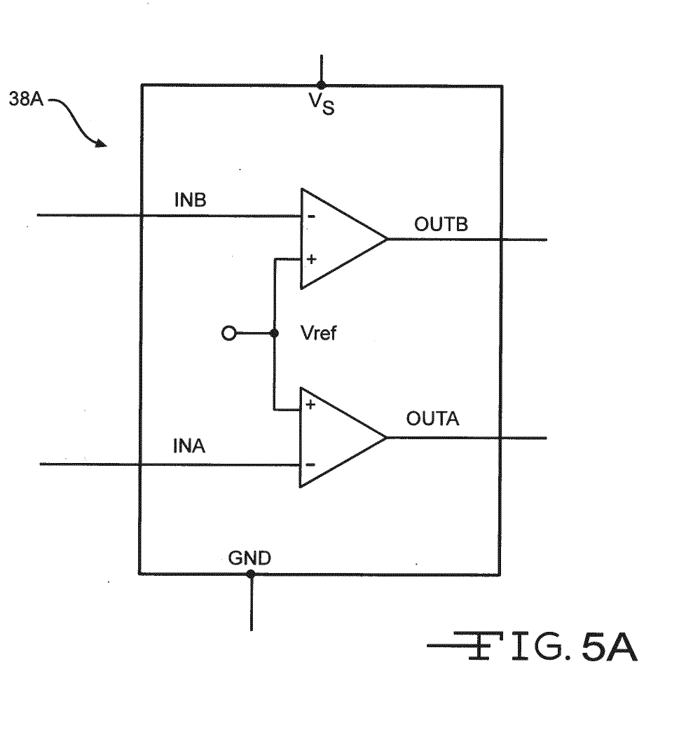

Now turning to the figures, FIGS. 1 and 5 illustrate an embodiment of an electrical schematic diagram of a voltage cutoff circuit 10 of the present invention. The electrical circuit 10 is designed to dynamically connect or disconnect an electrochemical cell 12 to or from an electrical load 14 based on the measured value of the discharge voltage 16 (FIG. 2) generated by the cell 12. More specifically, the electrical circuit 10 of the present invention is designed to either connect or disconnect the electrochemical cell 12 to the load 14 by actively monitoring and comparing the discharge voltage 16 of the electrochemical cell 12 to a cutoff threshold voltage. The circuit 10 of the present invention is configured such that when the discharge voltage 16 of the cell 12 is determined to be less than the cutoff threshold voltage, the cell 12 is disconnected from the electrical load 14. Likewise, when the discharge voltage 16 of the cell 12 is determined to be the same, or greater than the threshold voltage, the cell 12 is reconnected to the load 14.

As will be discussed in more detail, the circuit 10 comprises a series of resistors in combination with electrical switches, such as field effect transistors (FET). The switches are used to route the electrical current through the circuit 10. The resistors are arranged to establish a threshold voltage that is used as a determining value as to whether the cell 12 is connected to, or disconnected from, the electrical load 14. A sensing circuit 18, such as a voltage comparator 38 (FIG. 5), actively monitors and compares the discharge voltage 16 of the cell 12 to the threshold voltage value established by the arrangement of the resistors within the circuit 10. In addition, the sensing circuit 18 actuates the electrical switches that cause the electrochemical cell 12 to be connected or disconnected from the load 14. Furthermore, actuation of the electrical switches, by the sensing circuit 18, causes the electrical current of the electrochemical cell 12 to flow through a different arrangement of resistors that modify the cutoff threshold voltage from a first cutoff threshold voltage to a second cutoff threshold voltage, wherein the first and second threshold voltages are of different values. Therefore, the electrical circuit 10 of the present invention connects or disconnects the electrochemical cell 12 based on comparison of the cell's discharge voltage to that of a dynamically changing threshold voltage.

FIG. 2 illustrates a typical voltage discharge behavior of a primary lithium electrochemical cell under a constant or near constant current or power load. As shown, the cell's discharge voltage 16 decreases from an initial discharge voltage 20 of a fully charged cell under load. This decrease in discharge voltage 16 can be abrupt and occur as a precipitous drop 22 at near full depletion of the cell's voltage. Therefore, it is sometimes difficult to determine when the electrochemical cell 12 may become unstable. Thus, one means of improving safe operation of a cell, such as a primary lithium oxyhalide cell, is to choose a threshold cut off voltage that is greater than the discharge voltage at which the cell could become unstable, thereby providing a safety voltage buffer.

Referring back to FIG. 1, in a preferred embodiment the value of the first cutoff threshold voltage (V_{first}) is determined by a resistor divider 24, which comprises a first resistor R₁ and a second resistor R₂ that are connected in electrical series with each other. As illustrated in the electrical schematic diagram of FIGS. 1 and 5, the first and second resistors R₁, R₂ are positioned in opposition to each other about node 26. The value of the first cutoff threshold voltage is determined by the ratio of the first and second resistors R₁, R₂ at node 26. Thus, by selecting the appropriate resistors, the value of the threshold voltage of the cell 12 can be modified to suit the discharge voltage of a desired cell 12 for a specific application.

As illustrated in the electrical schematic diagrams of FIGS. 1 and 5, the first resistor R₁ is connected to a positive rail or power line 28 and the second resistor R₂ is connected to a negative rail or ground 30. It is noted that the resistors comprising the resistor divider 24 are sometimes referred to as a high side resistor and a low side resistor. In this case, the high side resistor is the first resistor R₁ and the low side resistor is the second resistor R₂. The value of the first cutoff threshold voltage is determined by equation 1 shown below:

$$Vfirst = \frac{( R 1 + R 2 ) \times Vref}{R 2} \qquad Equation 1$$

were R1 is the resistance value in ohms of the first resistor, R2 is the resistance value in ohms of the second resistor and V_{ref} is a reference voltage in volts that is internal to the sensing circuit 18, such as a voltage comparator 38 (FIG. 5).

As illustrated in the electrical schematic diagram of FIG. 1, the cutoff threshold voltage at node 26 is actively monitored and analyzed by the sensing circuit 18. In a preferred embodiment, the sensing circuit 18 dynamically compares the cutoff threshold voltage, generated at node 26, to that of the measured discharge voltage 16 of the cell 12. Actuation of the sensing circuit 18 is determined by comparison of the cutoff threshold voltage to the value of the discharge voltage 16 of the cell 12. If the value of the discharge voltage 16 is determined to be at least the same, or greater than that of the value of the cutoff threshold voltage, the cell 12 is connected to the electrical load 14. Likewise, if the value of the discharge voltage is determined to be less than the value of the cutoff threshold voltage, the cell 12 is disconnected from the electrical load 14. The value of the cutoff threshold voltage can be selected to be any desired value. Therefore, the value of the threshold voltage should be selected according to the specific chemistry of the electrochemical cell 12 such that the cell is disconnected from the load 14 at the appropriate cell discharge voltage prior to becoming unstable.

In a preferred embodiment, as illustrated in the electrical schematic diagram of FIG. 1, connection of the cell 12 to the load 14 is controlled through activation of electrical switches, particularly a first switch 32 and a second switch 34. If the value of discharge voltage 16 of the cell 12 is determined to be the same, or greater than, that of the value of the threshold voltage 16, the circuit 10 is configured such that the first switch 32 is in a closed position and the second switch 34 is in an open position. Actuation of the switches 32, 34 is controlled by the sensing circuit 18 which emits a signal to each of the respective switches. Thus, when the circuit 10 is configured to be connected to the load 14, the electrical current of the cell 12 is allowed to flow through power line 28 through the resistor divider 24 comprising resistor R₁ and R₂, the sensing circuit 18, and through the closed first switch 32 to power the load 14.

However, if the value of the discharge voltage 16 of the cell 12 is determined to be less than the value of the cutoff threshold voltage at node 26, the circuit 10 is configured so that the first switch 32 is in an open position. Thus, the electrical path to the load 14 is disconnected and current from the cell 12 is prevented from flowing to the load 14. In addition to opening the first switch 32, the sensing circuit 18 sends a signal to close the second switch 34. Thus, when the second switch 34 is closed, current is directed through a third resistor R₃.

As shown in the electrical schematic diagrams of FIGS. 1 and 5, the third resistor R₃ is electrically connected in parallel to the second resistor R₂ of the resistor divider 24. Thus, by adding the additional third resistor R₃ in parallel to the low side of the resistor divider 24, the ratio between the low and high side resistance is changed. Therefore, by changing the ratio between the high and low side of the resistor divider 24, the threshold voltage at node 26 is changed to a new, second cutoff threshold voltage value. More specifically, by adding the additional third resistor R₃ in parallel with the second resistor R₂, the cutoff threshold voltage is increased. Therefore, by effectively increasing the cutoff threshold voltage, the cell 12 is not reconnected to the load 14 until the discharge voltage of the cell 12 increases to a voltage that is at least the same as, or greater than that of the new second cutoff threshold voltage value. Like the first cutoff threshold voltage, the second cutoff threshold voltage is measured at node 26. This new, second threshold voltage value, which is greater than the first cutoff threshold voltage, is defined herein as the recovery voltage (Vrecovery) of the cell 12. Thus, for the cell 12 to be reconnected to the load 14, the discharge voltage 16 of the cell 12 must “recover” to a value that is at least the same as, or greater than, that of the second cutoff threshold voltage. The value of the second cutoff recovery voltage is mathematically calculated by equation 2 shown below:

$$Vsecond = \frac{( R 1 \times ( R 3 + R 2 ) + R 2 \times R 3 ) \times Vref}{R 2 \times R 3} \qquad Equation 2$$

were R1 is the resistance value in ohms of the first resistor, R2 is the resistance value in ohms of the second resistor, R3 is the resistance value in ohms of the third resistor, and Vref is the reference voltage of the sensing circuit 18 or voltage comparator 38 (FIG. 5).

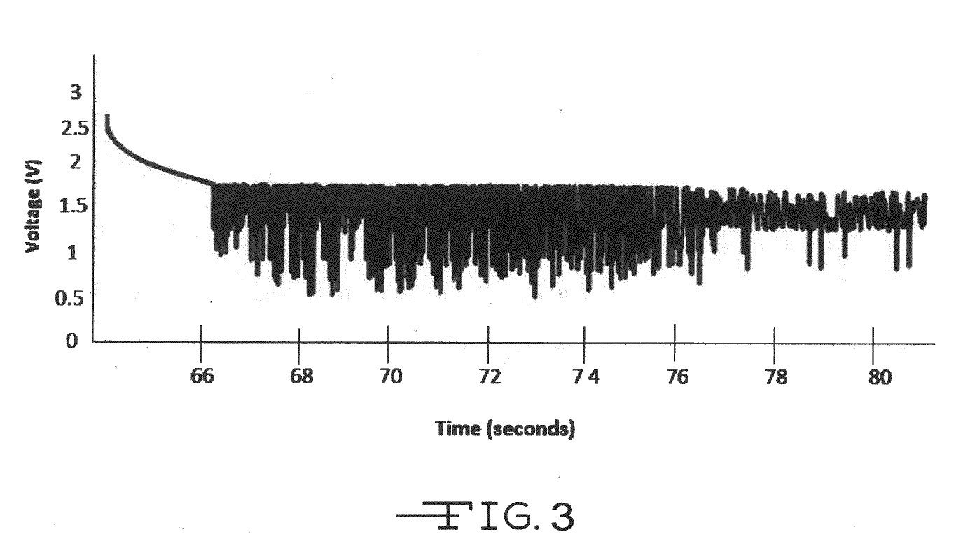

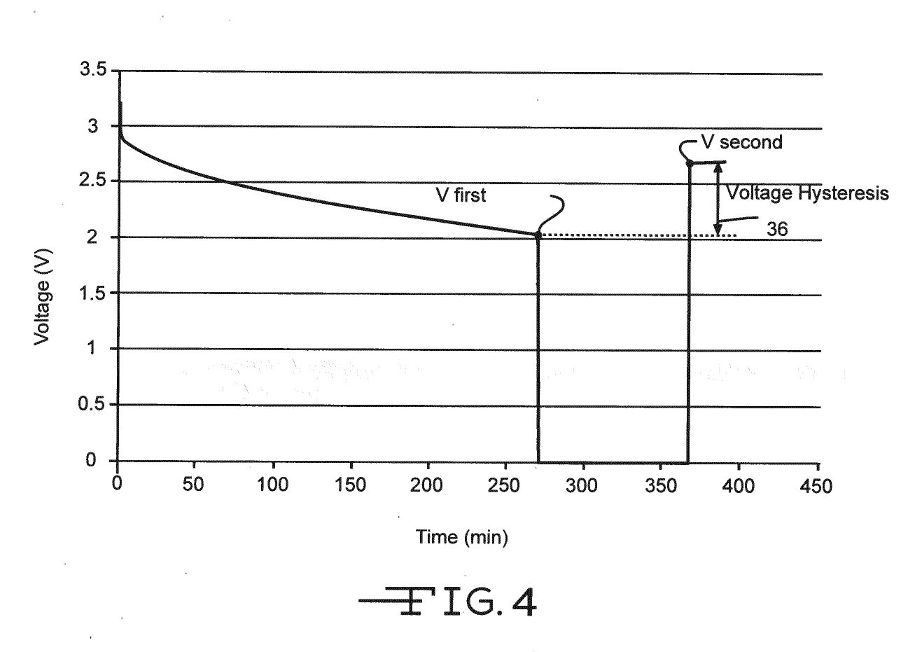

This increase in the value of the threshold voltage, created by the addition of the third resistor R₃, provides for a voltage hysteresis 36 (FIG. 4) that minimizes connect/disconnect or on/off oscillation. In general, when an electrical load 14 is connected to an electrochemical cell 12 the discharge voltage of the cell decreases. Likewise, when a load is disconnected from a cell 12, the discharge voltage of the cell typically increases as the cell relaxes. This relaxation behavior is typical of primary lithium electrochemical cells. Thus, without the voltage hysteresis 36 provided for by the third resistor R₃ within the electrical circuit 10 of the present invention, the circuit could oscillate very rapidly between respective “on” and “off” states as the sensing circuit 18 reacts to the changing discharge voltage. Hence, the discharge voltage 16 of the cell 12 could oscillate wildly between high and low voltages as the cell 12 is cyclically exercised and relaxed when connected and disconnected from the load 14. Such a rapid discharge oscillation behavior is illustrated in FIG. 3. As defined herein, the “on” state is when the cell 12 is connected to a load 14 and the “off” state is when the cell 12 is disconnected from the load 14. Such rapid “on” and “off” oscillations could create in-rush current whereby current from the cell 12 initially rushes in to power circuit components, such as capacitors, that may comprise the load 14. A rapidly oscillating “on” and “off” state is generally not desirable as this causes excessive wear of the circuit, which could result in circuit failure.

In comparison, FIG. 4 illustrates an example of the preferred voltage hysteresis response achieved by the electrical circuit 10 of the present invention. As shown, the discharge voltage 16 of the cell 12 slowly decreases until the first cutoff threshold voltage value is reached. In this example, the first cutoff threshold voltage is about 2.1V. Once the cutoff threshold voltage value is reached, the cell 12 is disconnected from the load 14, as the discharge voltage 16 is shown to drop to 0 V. After a period of about 100 seconds, as illustrated in the example, the discharge voltage of the cell has increased to at least the second cutoff threshold voltage or recovery voltage threshold voltage (about 2.6V) at which time, the cell is reconnected to the electrical load 14. However, once the cell 12 is reconnected to the load 14 through the closure of the first switch 32, the second switch 34 is also disconnected from the third resistor R₃. Thus, the cutoff threshold voltage reverts back to the lower, first cutoff threshold voltage value, as the electrical current is now passing through resisters R₁ and R₂ and not R₃, as governed by Equation 1.

In an illustrative example, it is assumed that the electrical circuit 10 of the present invention comprises a first resistor R₁ having a resistance value of 5K ohms, a second resistor R₂ having a resistance value of 10K ohms, and a third resistor R₃ having a resistance value of 15K ohms. It is also assumed that the voltage reference value of the sensing circuit 18 is 1V. Thus, per equations 1 and 2 shown above, the respective first cutoff threshold voltage and second cutoff threshold voltage values would equal:

$$Vfirst = \frac{( 5 K ohms + 10 K ohms ) \times 1 V}{10 K ohms} = 1.5 V$$

$$Vsecond = \frac{( \begin{matrix}5 K ohms \times ( \begin{matrix}15 K ohms + \\ 10 K ohms\end{matrix} ) + \\ 10 K ohms \times 15 K ohms\end{matrix} ) \times 1 V}{10 K ohms \times 15 K ohms} = 1.83 V$$

Thus, as shown in the example above, the second cutoff threshold voltage or recovery threshold voltage value is greater than that of the cutoff threshold voltage by 0.33V. Since the voltage hysteresis value equals the difference between the voltage recovery threshold value and the cutoff threshold voltage, the hysteresis value for this example is 0.33V.

FIG. 5 illustrates a preferred embodiment of an electrical schematic of the electrical circuit 10 of the present invention. As illustrated the circuit 10 comprises a voltage comparator 38 that actively monitors the discharge voltage of the cell 12 in comparison to the cutoff threshold voltage. In a preferred embodiment, the voltage comparator 38 is an inverting comparator wherein its voltage output is connected to an electrical ground. Alternatively, as illustrated in FIG. 5A, the electrical circuit 10 of the present invention may comprise a non-inverting voltage comparator 38A. In a preferred embodiment, capacitor C₁ may be electrically connected to the voltage comparator 38, 38A as a decoupling capacitor.

In a preferred embodiment, as shown in the electrical schematic diagram of FIG. 5, the discharge voltage of the cell 12 is actively monitored by the voltage comparator 38 which compares the dynamically changing discharge voltage 16 to that of the threshold voltage of the circuit 10. The threshold voltage is created by the arrangement of the resistors at node 26. Similarly to the circuit embodied in the schematic of FIG. 1, the first cutoff threshold voltage is determined by the ratio of resistors R₁ and R₂ that comprise the resistor divider 24. As previously disclosed, the first cutoff threshold value is calculated by Equation 1. However, in this case, V_{ref} would be equal to the internal reference voltage of the comparator 38, 38A.

As illustrated in the electrical schematic diagram of FIG. 5, connection of the cell 12 to the electrical load 14 is controlled through activation of at least one field effect transistors (FET). There is a first field effect transistor Q₁ and a second field effect transistor Q₂. In a preferred embodiment, the first field effect transistor Q₁ is a “p-channel” metal oxide semiconductor field effect transistor (MOSFET) and the second field effect transistor Q₂ is an “n-channel” metal oxide semiconductor field effect transistor (MOSFET), both of which comprise at least one source (S), one gate (G) and one drain (D). In a preferred embodiment, as shown in the electrical schematic diagram of FIG. 5, capacitors C₂ and/or C₃ may be electrically connected to the first field effect transistor Q₁ to shield the FET from electrostatic discharge.

In a preferred embodiment illustrated by the electrical schematic diagram of FIG. 5, if the discharge voltage 16 of the cell 12 is determined to be greater than that of the cutoff threshold voltage, the circuit 10 is configured such that the gate of the first FET Q₁ is in a closed position and the gate of the second FET Q₂ is in an open position. Thus, when the circuit 10 is configured to be electrically connected to the load 14, the electrical current of the cell 12 is allowed to flow through power line 28, through the resistor divider 24 comprising resistors R₁ and R₂, the voltage comparator 38, and the first FET Q₁ to power the load 14. Therefore, since the electrical current of the cell 12 flows through resistors R₁ and R₂ of the resistor divider, the value of the cutoff threshold voltage is governed by Equation 1, which determines the value of the first cutoff threshold voltage.

Likewise, if the discharge voltage 16 is determined to be less than the threshold voltage, the circuit 10 is configured such that the gate of the first FET Q₁ is in an open position. Therefore, since the electrical path to the load 14 is disconnected, the cell 12 is prevented from powering the load 14. So that current is directed through the third resistor R₃, the gate of the first FET Q₁ is open and the gate of the second FET Q₂ is closed. A voltage differential, created by resistor R₄, is used to pull up the gate of FET Q₁ and the gate of Q₂ to the voltage of Vcc. Voltage Vcc is the voltage input that provides electrical power to the components within the circuit 10. Therefore, since the electrical current of the cell 12 flows through resistors R₁, R₂ and R₃, the value of the cutoff threshold voltage is governed by Equation 2, which determines the value of the second cutoff threshold voltage.

As shown in the electrical schematic given in FIG. 5, a fuse F₁ may be electrically connected within the circuit 10 of the present invention. The fuse F₁ is incorporated into the circuit 10 to protect the cell 12 in the event of a short circuit. The incorporation of the fuse F₁ is particularly desirable when the cell 12 is utilized in hazardous environments, such as a flammable gas environment. Furthermore, the fuse F₁ should preferably be selected in compliance with IEC standard 60079-11. In a preferred embodiment, the fuse F₁ is positioned along power line 28 between the cell 12 and the first resistor R₁ such that in the unlikely event of an internal short, thermal energy and/or electrical current that would be emitted from the cell 12 would disconnect the fuse F₁ thereby, preventing potential damage to the connected load 14. In addition, the current rating of switch 32 (FIG. 1) or FET Q₁ (FIG. 5) should preferably be greater than that of the fuse F₁. Therefore, in an unlikely event of an electrical short, the fuse F₁ would disconnect the cell 12 from the circuit 10 before the switch 32 or FET Q₁ potentially overheats. Such overheating could potentially result in an undesirable thermal event, particularly in a hazardous environment.

In a preferred embodiment, the fuse F₁ may comprise a single piece of metal or alternatively, may comprise at least two wires that are intertwined. The fuse F₁ may be composed of a metal selected from the group consisting of stainless steel, stainless steel alloys, copper, nickel, nickel alloys, silver, tin and combinations thereof. In either case, it is preferred that the fuse F₁ is of a “fast disconnect” type in that the fuse disconnects before a voltage drop resulting from a short circuit event is seen. Furthermore, the fuse F₁ may be selected such that the current sufficient to cause the fuse to separate is in the range of 500 mA to about 20 A.

In addition, a current limiting resistor R₅ may also be incorporated within the circuit 10. Preferably, the current limiting resistor R₅ is electrically connected in series with the fuse F₁ and the cell 12. In a preferred embodiment, the value of the current limiting resistor R₅ may range from about 50 mΩ to about 500 mΩ. The combination of the current limiting resistor R₅ with that of the fuse F₁ adds an additional level of safety for minimizing the potential of a thermal event.

Furthermore, as illustrated in the electrical schematic given in FIG. 5, the electrical circuit 10 of the present invention may also comprise protection diodes D₁ and/or D₂. Protection diodes D₁ and D₂ are preferably incorporated within the circuit 10 to prevent charging of the cell 12. These protection diodes are particularly beneficial when the cell 12 is of a primary electrochemistry such, as a primary lithium oxyhalide cell. Electrical charging of a lithium oxyhalide cell may lead to cell heating and possible venting of the cell. In a preferred embodiment, diodes D₁ and/or D₂ may comprise a Shottky barrier diode having a maximum peak reverse voltage of between about 10V to about 100V. Alternatively, a resistor R₅ may be used with or in lieu of the diode D₁, D₂.

The electrochemical cell 12 can be a primary or a secondary cell. However, in a preferred embodiment, the electrochemical cell 12 is of a primary electrochemical chemistry. The cell chemistry can be, for example, a magnesium electrochemical cell, a zinc manganese electrochemical cell, a nickel-metal hydride electrochemical cell, or a lithium electrochemical cell. Preferably, the cell is of a primary lithium oxyhalide cell. More preferably, the cell is of a primary lithium thionyl chloride electrochemical cell.

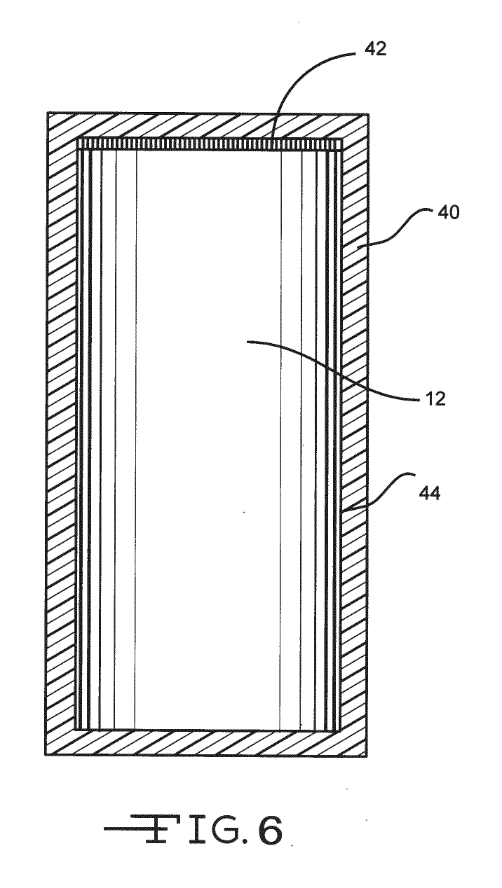

FIG. 6 illustrates a preferred embodiment in which the electrochemical cell 12 may be encased in a layer 40 of encapsulate material. Preferably, the encapsulate is of a non-electrically and/or a non-thermally conductive material. Non limiting examples include, but are not limited to, polymeric epoxies and resins such as urethane. In a preferred embodiment, the thickness of the layer ranges from 0.005 inches to about 0.025 inches. This layer of encapsulate material provides an added layer of protection in the unlikely event of a short circuit or other thermal event such as discharging the cell past its useful life. As shown in the cross-sectional view, a circuit board 42 comprising an electrical circuit is electrically connected to the cell 12. In a preferred embodiment, the circuit board 42 is shown positioned on an external side of a casing 44 for the cell 12. The layer of encapsulate material encases both the cell 12 and the circuit board 42 therewithin. Alternatively, the circuit board 42 may be positioned within the cell casing 44. In a preferred embodiment, the circuit board 42 may comprise the electrical circuit 10 of the present invention or a portion thereof.

The primary chemistry configuration can include a positive electrode of either a solid cathode active material supported on a current collector or a liquid catholyte system having an electrically conductive or electroactive material supported on the cathode current collector.

Regardless of the cell configuration, such primary oxyhalide cells preferably comprise an anode active material of a metal selected from Groups IA, IIA or IIIB of the Periodic Table of the Elements, including the alkali metals lithium, sodium, potassium, etc., and their alloys and intermetallic compounds including, for example, Li—Mg, Li—Si, Li—Al, Li—B, Li—Al—Mg and Li—Si—B alloys and intermetallic compounds. The preferred anode active material comprises lithium.

In a primary cell of either a solid positive electrode or an oxyhalide chemistry, the form of the anode may vary. Preferably the anode is a thin metal sheet or foil of the anode metal, pressed or rolled on a metallic anode current collector, i.e., preferably comprising nickel, to form an anode component. The anode component has an extended tab or lead of the same material as the anode current collector, i.e., preferably nickel, integrally formed therewith such as by welding and contacted by a weld to a cell case of conductive metal in a case-negative electrical configuration. Alternatively, the anode may be formed in some other geometry, such as a bobbin shape, cylinder or pellet to allow an alternate low surface cell design.

In the case of an oxyhalide chemistry, the cell comprises a cathode current collector of electrically conductive material supported on a conductive substrate. An oxyhalide cell operates in the following manner. When the ionically conductive catholyte solution becomes operatively associated with the anode and the cathode current collector, an electrical potential difference develops between terminals operatively connected to the anode and cathode current collector. The electrochemical reaction at the anode includes oxidation to form metal ions during cell discharge. The electrochemical reaction at the cathode current collector involves conversion of those ions which migrate from the anode to the cathode current collector into atomic or molecular forms. In addition, the halogen and/or interhalogen of the catholyte is believed to undergo a reaction or reactions with the nonaqueous solvent thereof resulting in the formation of a compound or complex which exhibits the observed open circuit voltage of the cell. Exemplary electrically conductive materials for the cathode current collector include graphite, coke, acetylene black, carbon black, and carbon monofluoride bonded on metal screens.

For an oxyhalide chemistry, the cell further comprises a nonaqueous, ionically conductive catholyte operatively associated with the anode and the cathode current collector. In a cell chemistry having a solid positive electrode, the anode and cathode electrodes are activated with an ionically conductive electrolyte. In either case, the catholyte and the electrolyte serve as a medium for migration of ions between the anode and the cathode current collector in the case of the oxyhalide chemistry and between the anode and the cathode electrodes in the solid positive electrode chemistry during the cell's electrochemical reactions.

For an oxyhalide cell, suitable nonaqueous solvent depolarizers exhibit those physical properties necessary for ionic transport, namely, low viscosity, low surface tension and wettability. In the case of a catholyte, suitable nonaqueous depolarizers are comprised of an inorganic salt dissolved in a nonaqueous codepolarizer system and, more preferably, an alkali metal salt dissolved in a catholyte solution comprising a halogen and/or interhalogen dissolved in a nonaqueous solvent. The halogen and/or interhalogen serve as a soluble depolarizer. They also can serve as a cosolvent in the electrochemical cell. The halogen is selected from the group of iodine, bromine, chlorine or fluorine while the interhalogen is selected from the group of CIF, ClF₃, ICl, ICl₃, IBr, IF₃, IF₅, BrCl, BrF, BrF₃, BrF₅, and mixtures thereof. The mole ratio of any one of the above-referenced halogens and/or interhalogens dissolved in any one of the above-referenced nonaqueous organic or inorganic solvents is from about 1:6 to about 1:1.

The nonaqueous solvent depolarizer may be one of the organic solvents which is substantially inert to the anode and cathode current collector materials. Those include tetrahydrofuran, propylene carbonate, acetonitrile, dimethyl sulfoxide, dimethyl foramide, dimethyl acetamide and in particular halogenated organic solvents such as 1,1,1,2,3,3,3-heptachloropropane or 1,4-difluorooctachlorobutane. The nonaqueous solvent depolarizer also may be one or a mixture of more than one of the inorganic solvents which can serve as both a solvent and a depolarizer, such as thionyl chloride, sulfuryl chloride, selenium oxychloride, chromyl chloride, phosphoryl chloride, phosphorous sulfur trichloride and others.

The ionic conductivity of the nonaqueous catholyte solution is preferably facilitated by dissolving a metal salt in the nonaqueous depolarizer. Examples of metal salts are lithium halides such as LiCl and LiBr and lithium salts of the LiMX, type, such as LiPF₆, LiBF₄, LiAsF₆, LiSbF₆, LiClO₄, LiAlCl₄, LiGaCl₄, LiC(SO₂CF₃)₃, LiN(SO₂CF₃)₂, LiSCN, LiO₃SCF₂CF₃, LiC₆FsSO₃, LiO₂, LiO₂CCF₃, LiSO₃F, LiB(C₆H₅)₄, LiCF₃SO₃, and mixtures thereof. Suitable salt concentrations typically range between about 0.25 to about 1.5 molar. Thus, the solution of halogen and/or interhalogens, the nonaqueous solvent depolarizer and, optionally, the ionic salt, serve as the codepolarizer and catholyte of the oxyhalide cell.

In electrochemical systems of either a primary or a secondary chemistry having a solid cathode or solid positive electrode, the nonaqueous solvent system comprises low viscosity solvents including tetrahydrofuran (THF), methyl acetate (MA), diglyme, trigylme, tetragylme, dimethyl carbonate (DMC), ethylmethyl carbonate (EMC), 1,2-dimethoxyethane (DME), diisopropylether, 1,2-diethoxyethane, 1-ethoxy, 2-methoxyethane, dipropyl carbonate, ethylmethyl carbonate, methylpropyl carbonate, ethylpropyl carbonate, diethyl carbonate, and mixtures thereof. While not necessary, the electrolyte also preferably includes a high permittivity solvent selected from cyclic carbonates, cyclic esters and cyclic amides such as propylene carbonate (PC), ethylene carbonate (EC), butylene carbonate, acetonitrile, dimethyl sulfoxide, dimethyl formamide, dimethyl acetamide, γ-butyrolactone (GBL), γ-valerolactone, N-methyl-pyrrolidinone (NMP), and mixtures thereof. The nonaqueous solvent system also includes at least one of the previously described lithium salts in a concentration of about 0.8 to about 1.5 molar. For a solid cathode primary or secondary cell having lithium as the anode active material, such as of the Li/SVO couple, the preferred electrolyte is LiAsF₆ in 50:50, by volume, mixture of PC/DME. For a Li/CFₓ cell, the preferred electrolyte is 1.0M to 1.4M LiBF₄ in γ-butyrolactone (GBL).

It is appreciated that various modifications to the inventive concepts described herein may be apparent to those of ordinary skill in the art without departing from the spirit and scope of the present invention as defined by the appended claims.

What is claimed is:

1. An electrical circuit, comprising:
a) an electrochemical cell capable of generating an electrical current comprising a discharge voltage to thereby power an electrical load;
b) a sensing circuit electrically connected to the electrochemical cell, wherein the sensing circuit is configured to measure the discharge voltage generated by the electrochemical cell;
c) at least a first and second resistor configured to generate a first threshold voltage value and a second threshold voltage value that are different;
d) at least one electrical switch electrically connected to the sensing circuit, wherein the at least one electrical switch is capable of electrically connecting and disconnecting the electrochemical cell to the electrical load; and
e) wherein actuation of the sensing circuit causes the at least one electrical switch to disconnect the electrochemical cell from the electrical load when the discharge voltage value is determined to be less than the first threshold voltage value and cause the sensing circuit to reconnect the electrochemical cell to the electrical load when the discharge voltage value is the same as, or greater than, the second threshold voltage value, the second threshold voltage value being greater than the first voltage value.

2. The electrical circuit of claim 1 further comprising a resistor divider electrically connected to the electrochemical cell, the resistor divider comprising a first resistor electrically connected in series to a second resistor, wherein the resistor divider establishes a first cutoff threshold voltage.

3. The electrical circuit of claim 2 further comprising a third resistor electrically connected in parallel to the second resistor.

4. The electrical circuit of claim 3 further comprising a second sensing circuit, wherein the second switch is capable of electrically connecting and disconnecting the electrochemical cell to the third resistor.

5. The electrical circuit of claim 1 further comprising a first electrical switch, wherein the first switch is capable of electrically connecting and disconnecting the electrochemical cell to the electrical load.

6. The electrical circuit of claim 1 wherein the electrochemical cell is a primary cell or a rechargeable cell.

7. The electrical circuit of claim 1 wherein the at least one sensing circuit comprises a voltage comparator.

8. The electrical circuit of claim 1 further comprising a fuse and/or a diode electrically connected therewithin.

9. The electrical circuit of claim 1 wherein the first threshold voltage is defined by the equation:
$$Vfirst = \frac{( R 1 + R 2 ) \times Vref}{R 2}$$
wherein R1 is a resistance value of the first resistor, R2 is a resistance value of the second resistor and Vref is a reference voltage of the sensing circuit.

10. The electrical circuit of claim 1 wherein the second threshold voltage is defined by the equation:
$$Vsecond = \frac{( R 1 \times ( R 3 + R 2 ) + R 2 \times R 3 ) \times Vref}{R 2 \times R 3}$$
wherein R1 is a resistance value of the first resistor, R2 is a resistance value of the second resistor, R3 is a resistance value of a third resistor and Vref is a reference voltage of the sensing circuit.

11. An electrical circuit, comprising:
a) an electrochemical cell capable of generating an electrical current comprising a discharge voltage to thereby power an electrical load;
b) a sensing circuit electrically connected to the electrochemical cell, wherein the sensing circuit is configured to measure the discharge voltage generated by the electrochemical cell;
c) a resistor divider electrically connected to the electrochemical cell, the resistor divider comprising a first resistor electrically connected in series to a second resistor, wherein the resistor divider establishes a first cutoff threshold voltage;
d) a third resistor electrically connected in parallel to the second resistor;
e) a first electrical switch and a second electrical switch electrically connected to the sensing circuit, wherein the first switch is capable of electrically connecting and disconnecting the electrochemical cell to the electrical load and the second switch is capable of electrically connecting and disconnecting the electrochemical cell to the third resistor;
f) wherein actuation of the sensing circuit causes the first switch to be in a closed position so that the electrochemical cell is electrically connected to the electrical load and the second switch to be in an open position so that the electrochemical cell is electrically disconnected from the third resistor when the discharge voltage value is determined to be the same as, or greater than, the first cutoff threshold voltage; and
g) wherein actuation of the sensing circuit causes the first switch to be in an open position so that the electrochemical cell is electrically disconnected from the electrical load and the second switch to be in a closed position so that the electrochemical cell is electrically connected to the third resistor when the measured discharge voltage value is determined to be less than the first cutoff threshold voltage.

12. The electrical circuit of claim 11 wherein the electrochemical cell is a primary cell or a rechargeable cell.

13. The electrical circuit of claim 11 wherein the primary cell comprises:
a) a casing;
b) a cathode current collector and a first electrode comprising lithium positioned within the casing; and
c) a catholyte comprising an inorganic depolarizer solvent provided with a halogen or an interhalogen dissolved therein.

14. The electrical circuit of claim 13 wherein the interhalogen is selected from the group consisting of ClF, ClF₃, ICL, ICl₃, IBr, IF3, IF₅, BrCl, BrF, BrF₃, BrF₅, and mixtures thereof.

15. The electrical circuit of claim 13 wherein the halogen is selected from the group consisting of iodine, bromine, chlorine, fluorine, and mixtures thereof.

16. The electrical circuit of claim 13 wherein the inorganic solvent is selected from the group consisting of thionyl chloride, sulfuryl chloride, phosphoryl chloride, and mixtures thereof.

17. The electrical circuit of claim 13 wherein the first electrode comprises a lithium alloy selected from the group consisting of Li—Mg, Li—Si, Li—Al, Li—B, Li—Si—B, Li—Al—Mg, and mixtures thereof.

18. The electrical circuit of claim 13 wherein the catholyte includes at least one salt selected from the group consisting of LiCl, LiBr, and mixtures thereof.

19. The electrochemical cell of claim 13 further including a separator provided intermediate the first electrode and the cathode current collector to prevent direct physical contact therebetween.

20. The electrical circuit of claim 11 wherein the sensing circuit comprises a voltage comparator.

21. The electrical circuit of claim 20 wherein the voltage comparator is an inverted voltage comparator.

22. The electrical circuit of claim 11 wherein the first switch and the second switch comprise a metal oxide semiconductor field effect transistor.

23. The electrical circuit of claim 11 wherein the first switch comprises an “p-channel” field effect transistor.

24. The electrical circuit of claim 11 wherein the second switch comprises a “n-channel” field effect transistor.

25. The electrical circuit of claim 11 further comprising a fuse and/or a diode electrically connected therewithin.

26. The electrical circuit of claim 11 wherein the first threshold voltage is defined by the equation:
$$Vfirst = \frac{( R 1 + R 2 ) \times Vref}{R 2}$$
wherein R1 is a resistance value of the first resistor, R2 is a resistance value of the second resistor and Vref is a reference voltage of the sensing circuit.

27. The electrical circuit of claim 11 wherein actuation of the sensing circuit causes the first switch to be in an open position so that the electrochemical cell is electrically disconnected from the electrical load and the second switch to be in a closed position so that the electrochemical cell is electrically connected to the third resistor, the first threshold voltage having been modified to a second threshold voltage greater than the first threshold voltage.

28. The electrical circuit of claim 27 wherein the second threshold voltage is defined by the equation:
$$Vsecond = \frac{( R 1 \times ( R 3 + R 2 ) + R 2 \times R 3 ) \times Vref}{R 2 \times R 3}$$
wherein R1 is a resistance value of the first resistor, R2 is a resistance value of the second resistor, R3 is a resistance value of the third resistor and Vref is a reference voltage of the sensing circuit.

29. The electrical circuit of claim 27 wherein actuation of the sensing circuit causes the first switch to be in a closed position so that the electrochemical cell is electrically connected to the electrical load and the second switch to be in an open position so that the electrochemical cell is electrically disconnected from the third resistor when the discharge voltage value is determined to be the same as, or greater than, the second threshold voltage.

30. The electrical circuit of claim 11 wherein an encapsulate material selected from the group of materials consisting of a polymeric epoxy, a polymeric resin, urtethane, and combinations thereof encases the electrochemical cell therewithin.
